(19) United States
(12) Patent Application Publication
(10) Pub. No.: US 2003/0075646 A1
(43) Pub. Date: Apr. 24, 2003

(54) Cable management device

(76) Inventors: Christopher C. Womack, Dallas, TX (US); Martha G. Peterson, McKinney, TX (US)

Correspondence Address: HEWLETT-PACKARD COMPANY, Intellectual Property Administration, P.O. Box 272400, Fort Collins, CO, 80527-2400, US

(21) Appl. No.: 10/008,086

(22) Filed: Oct. 18, 2001

(51) Int. Cl. F16L 3/00

(52) U.S. Cl. 248/49

(57) ABSTRACT

An inexpensive, flexible cable management device is constructed from a thin sheet of flexible material by cutting slits or openings in the material configured to efficiently and compactly route cables within an electrical system. Information such as assembly instructions and wiring diagrams may be printed on the device, and adhesive may be applied to the device to ease installation. The cable management device may be bent to allow three-dimensional routing of cables and to act as a barrier between air flows.

### FIELD OF THE INVENTION

The present invention relates generally to the field of electrical cables and more specifically to the routing of electrical cables within an electrical system.

### BACKGROUND OF THE INVENTION

Complex electrical systems such as large computers often include a number of electrical cables within their chassis that need to be routed from one electrical connection to another. These cables may be bulky, particularly if they are power supply cables, and if allowed to hang loose within the chassis, may get in the way, or be damaged during use or repairs of the electrical system. Commonly, cable ties are used to bundle the cables together and to attach the bundles of cables to the chassis. However, in some applications, these bundles of cables may have too high of a profile to fit within the open spaces in the chassis. Also, when a single cable needs to be replaced, it is time consuming to open all of the bundles, replace the cable and re-bundle and re-route the cables.

When cables are routed individually within a system, other problems arise. First, routing individual cables is time consuming and costly since many more clips and clamps are required than would be used with a bundle of cables. Second, cable clips and clamps may be high profile, limiting their use in tight spaces. Lastly, the chassis may not have sufficient locations available for attachment of cable clips and clamps, limiting the number of cables that may be routed within the chassis.

### SUMMARY OF THE INVENTION

An inexpensive, flexible cable management device is constructed from a thin sheet of flexible material by cutting slits or openings in the material configured to efficiently and compactly route cables within an electrical system. Information such as assembly instructions and wiring diagrams may be printed on the device, and adhesive may be applied to the device to ease installation. The cable management device may be bent to allow three-dimensional routing of cables and to act as a barrier between air flows.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows an example embodiment of a cable management device according to the present invention.

FIG. 2 shows an example embodiment of the cable management device of FIG. 1 as used in routing cables according to the present invention.

FIG. 3 shows an example embodiment of a cable management device according to the present invention.

FIG. 4 shows an example embodiment of a cable management device according to the present invention.

FIG. 5 is a flow chart of a method of manufacturing a cable management device according to the present invention.

FIG. 6 shows an example embodiment of a cable management device according to the present invention.

FIG. 7 shows an example embodiment of a cable management device according to the present invention.

FIG. 8 is an example embodiment of a computer system including a cable management device according to the present invention.

### DETAILED DESCRIPTION

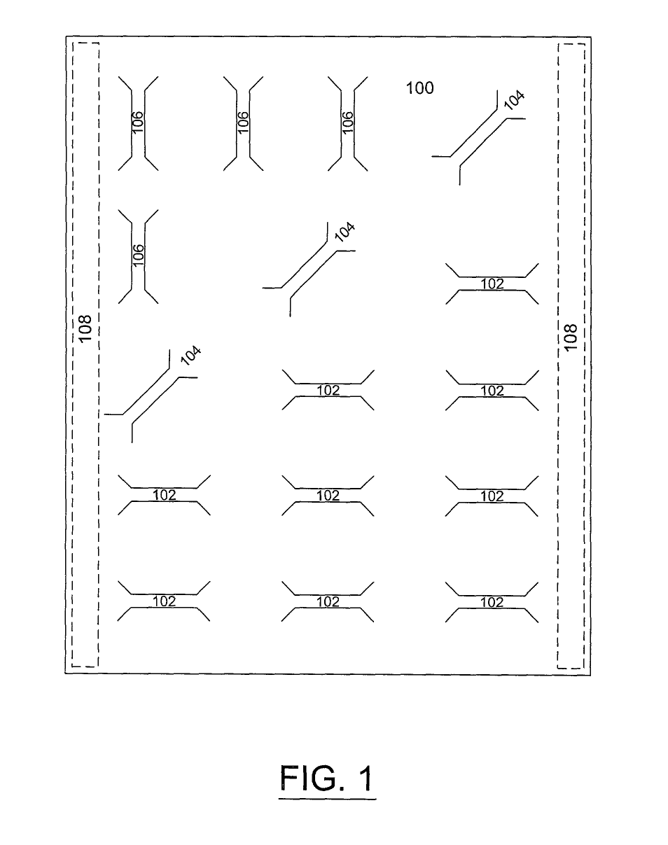

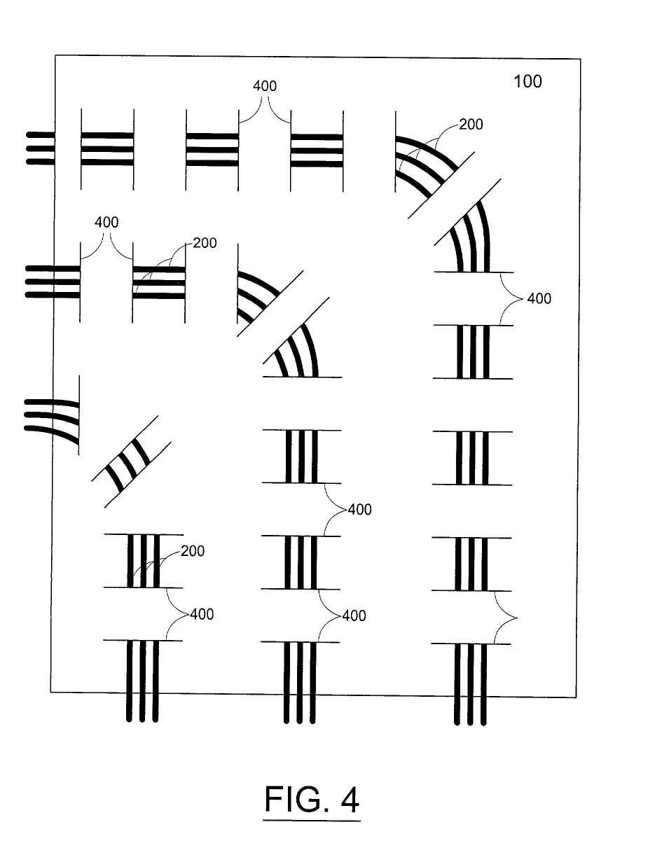

FIG. 1 shows an example embodiment of a cable management device according to the present invention. A thin, flexible sheet 100 of material such as plastic, is cut with a plurality of pairs of slits. These pairs of slits include horizontal slits 102, for routing cable vertically, diagonal slits 104, for routing cable at an angle, and vertical slits 106, for routing cable horizontally. The slits 102, 104, and 106 shown in FIG. 1 are configured to route three groups of cables from the bottom of the device to the left side of the device. The two slits forming each pair of slits may be substantially parallel to each other in an example embodiment of the present invention. However, other embodiments may not use pairs of slits, but simply weave the cables above and below the sheet through a series of individual slits as shown in FIG. 4. Note that the material used may vary according to needs of the user. A preferred embodiment of the present invention uses static dissipative polypropylene for the thin, flexible sheet 100. The cable management device may be attached to a chassis by an adhesive layer 108 or other means of attachment such as tabs on the edges of the thin, flexible sheet 100 fitting into chassis holes or slots. Many other means of attachment such as screws, bolts, rivets, snaps, hook-and-loop fasteners, glue, cement, silicone, tape, clips, clamps, and nails may be used to attach the cable management device to a chassis or other container. Since the final cable assembly is flexible, it may be bent or curved into a three-dimensional shape to fit the needs of any particular cable routing needs. Further, when installed in a chassis, the finished cable assembly may also act as a barrier between two or more substantially separate air flows. For example, in a computer system it may be used to maintain separation between an incoming air flow, and an outgoing air flow to improve the cooling capability of the fans in the computer system. Those skilled in the art will recognize that control of air flow within a chassis may be desired for multiple reasons, such as a desire to route hot air to an air conditioner return vent, or to route hot air away from adjacent computer systems.

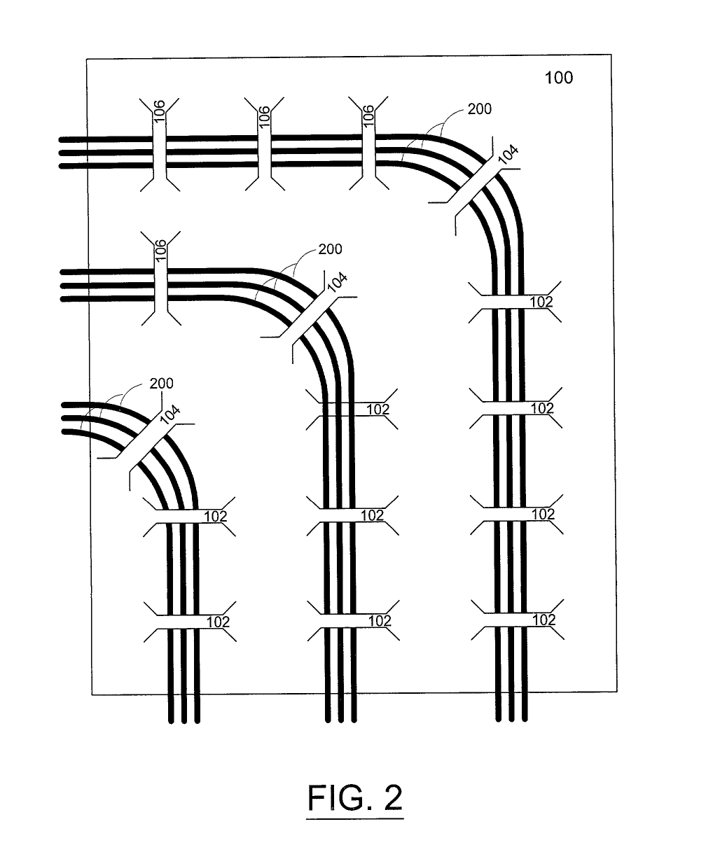

FIG. 2 shows an example embodiment of the cable management device of FIG. 1 as used in routing cables according to the present invention. The cable management device shown in FIG. 2 is the same as shown in FIG. 1 with the addition of a plurality of cables 200 woven through the slits 102, 104, and 106. In the example embodiment of the present invention shown in FIG. 2, three groups of three cables 200 each are shown making a left turn. Note that the ends of the cables 200 may be finished as required for connection to electrical devices, and that the ends are not shown in FIG. 2. The groups of cables may be arranged as needed to match the connections on the electrical devices to which they are attached. Also, in some embodiments of the present invention, they may be arranged as needed to reduce inductive coupling between cables. For example, cables for high-speed data may be interspersed between direct current power supply cables, and away from alternating current power supply cables to reduce cable-to-cable inductive coupling, in much the same way as a ribbon cable is typically used. Since the slits tend to flatten each group of cables, the resulting mass of cables may be used to route cables through areas with very little vertical clearance. This would not be feasible if the same groups of cables were simply bundled together using cable ties.

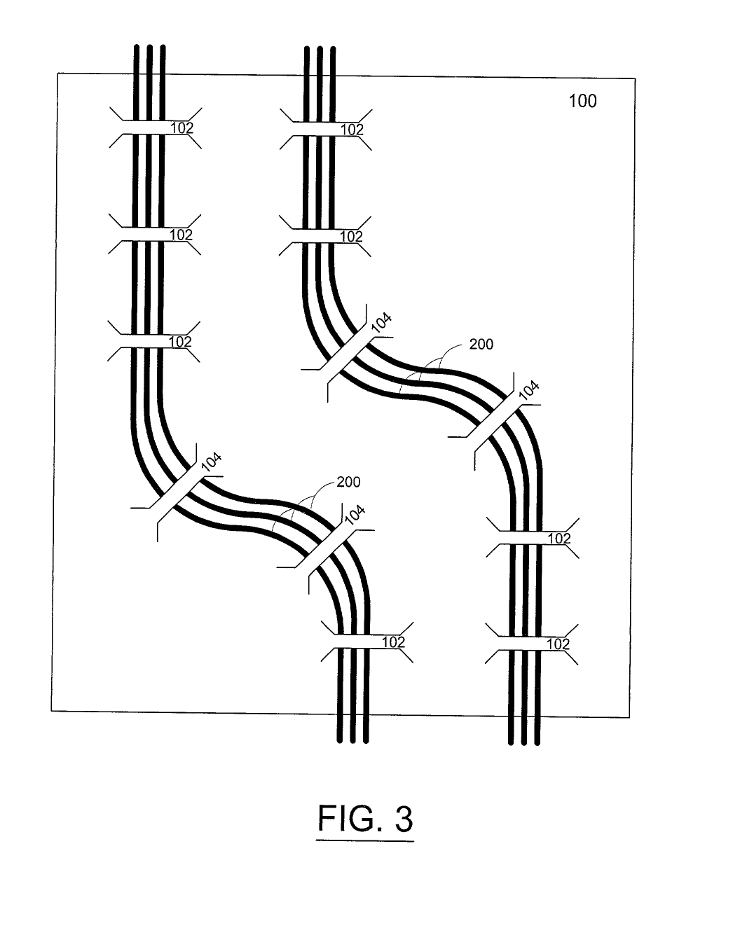

FIG. 3 shows an example embodiment of a cable management device according to the present invention. The example embodiment of the present invention shown in FIG. 3 is substantially similar to the embodiment of FIG. 2, except that the cables make a jog to the left and exit at the top of the cable management device.

FIG. 4 shows an example embodiment of a cable management device according to the present invention. The embodiments of the present invention shown in FIG. 1 through FIG. 3 all include pairs of slits used to route cables. The example embodiment of the present invention shown in FIG. 4 uses single slits 400 to accomplish the same task as the cable management device of FIG. 2. Instead of passing the cables under the tabs created by the pairs of slits 102, 104, and 106 in previously described embodiments, the cables are woven through the slits 400 in the sheet.

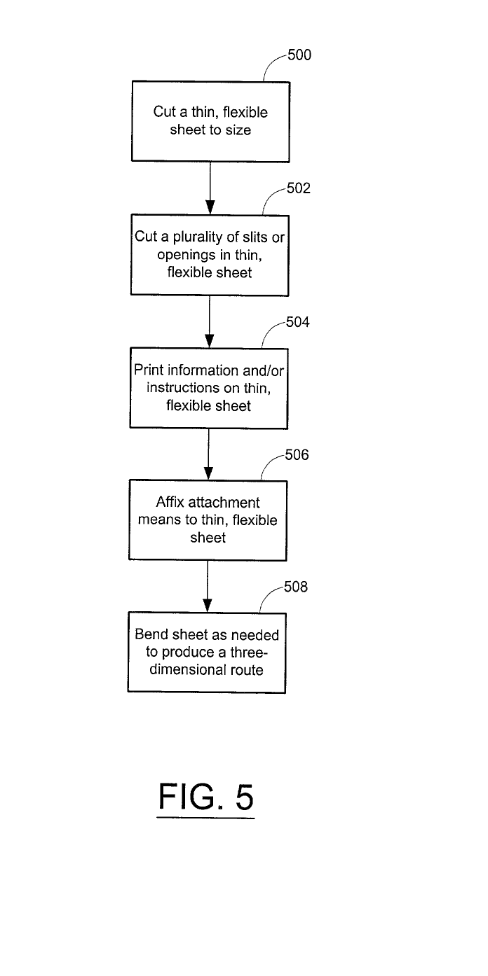

FIG. 5 is a flow chart of a method of manufacturing a cable management device according to the present invention. In a step 500, a thin, flexible sheet of material is cut to a desired size. In a step 502, a plurality of slits is cut into the thin, flexible sheet of material. In a step 504, instructions and other information is printed on to the thin, flexible sheet of material. In a step 506, attachment means are affixed to the thin, flexible sheet of material. In an example embodiment of the present invention, these attachment means include adhesive applied to one side of the thin, flexible sheet, however, many other attachment means as described in the detailed description of FIG. 1 are included within the scope of the present invention. In a step 508, the thin flexible sheet of material is bent as needed to produce a three-dimensional cable route. Note that there is no order dependency to these steps. The steps may be performed in any order. In some embodiments of the present invention, the thin, flexible material may be purchased in long rolls, and productivity may dictate printing any information on the material before any cutting is done. Alternatively, the material may be printed at a location, packaged and sent to another location for the cutting steps. In this process, the material may be rolled for shipping after printing, then unrolled for cutting at a later time.

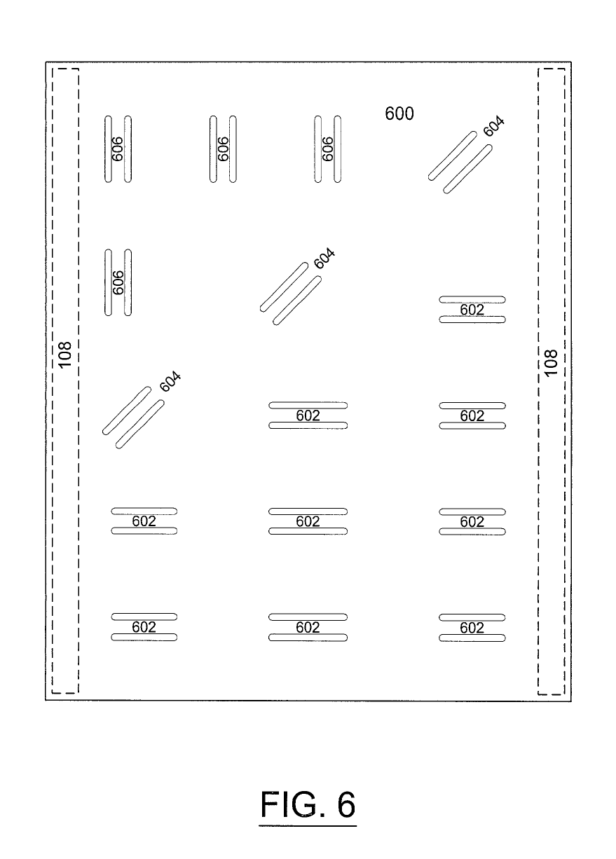

FIG. 6 shows an example embodiment of a cable management device according to the present invention. A thin, flexible sheet 600 of material such as plastic, is cut with a plurality of pairs of openings. While this example embodiment of the present invention includes oval shaped openings, other shapes of openings, such as circular, square, and rectangular, may be used within the scope of the present invention. These pairs of openings include horizontal openings 602, for routing cable vertically, diagonal openings 604, for routing cable at an angle, and vertical openings 606, for routing cable horizontally. The openings 602, 604, and 606 shown in FIG. 6 are configured to route three groups of cables from the bottom of the device to the left side of the device. The two openings forming each pair of openings may be substantially parallel to each other in an example embodiment of the present invention. However, other embodiments may not use pairs of openings, but simply weave the cables above and below the sheet through a series of individual openings similar to the configuration of slits shown in FIG. 4. Note that the material used may vary according to needs of the user. A preferred embodiment of the present invention uses static dissipative polypropylene for the thin, flexible sheet 600. The cable management device may be attached to a chassis by an adhesive layer 108 or other means of attachment as described in the detailed description of FIG. 1.

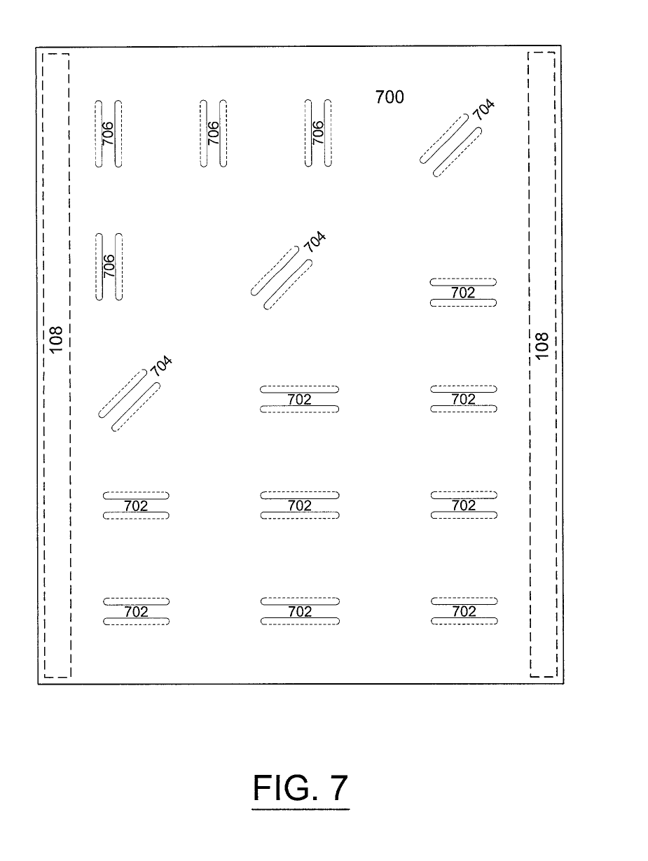

FIG. 7 shows an example embodiment of a cable management device according to the present invention. In some embodiments of the present invention, an opening similar to those shown in FIG. 6 may be desired, but it may also be desirable to avoid the proliferation of the small pieces of plastic removed from the openings. These small pieces of plastic, similar to confetti, may create problems if allowed to get loose within a computer chassis. Instead of cutting openings, slits of a similar shape may be cut, leaving one side of what would be a piece of confetti attached to the thin, flexible sheet 700. A thin, flexible sheet 700 of material such as plastic, is cut with a plurality of pairs of slits. While this example embodiment of the present invention includes oval shaped slits, other shapes of slits, such as circular, square, and rectangular, may be used within the scope of the present invention. These pairs of slits include horizontal slits 702, for routing cable vertically, diagonal slits 704, for routing cable at an angle, and vertical slits 706, for routing cable horizontally. The slits 702, 704, and 706 shown in FIG. 7 are configured to route three groups of cables from the bottom of the device to the left side of the device. The two slits forming each pair of slits may be substantially parallel to each other in an example embodiment of the present invention. However, other embodiments may not use pairs of slits, but simply weave the cables above and below the sheet through a series of individual slits similar to the configuration shown in FIG. 4. Note that the material used may vary according to needs of the user. A preferred embodiment of the present invention uses static dissipative polypropylene for the thin, flexible sheet 700. The cable management device may be attached to a chassis by an adhesive layer 108 or other means of attachment as described in the detailed description of FIG. 1.

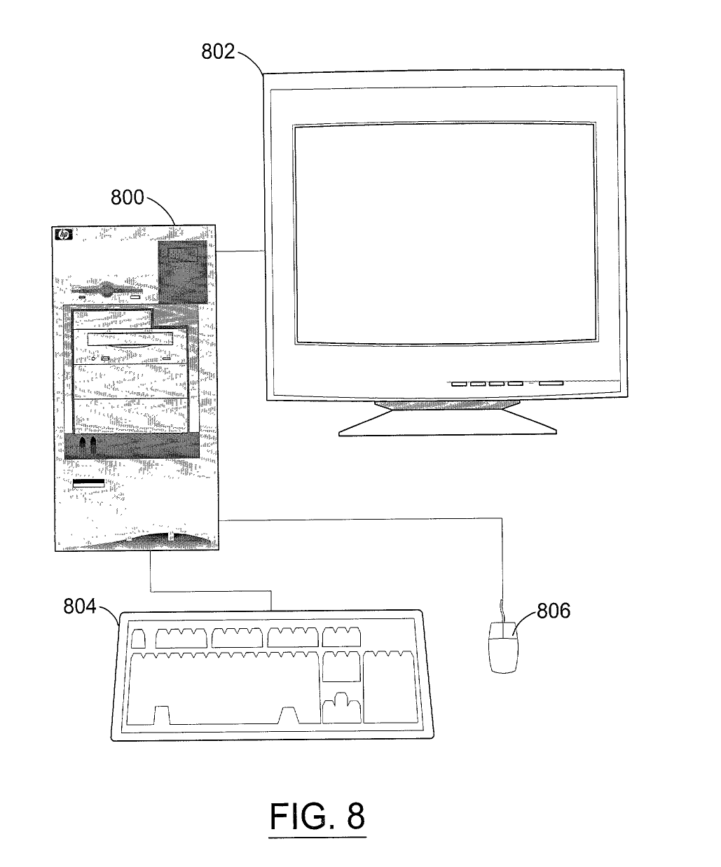

FIG. 8 is an example embodiment of a computer system including a cable management device according to the present invention. In an example embodiment of a computer system including the present invention, a computer chassis 800 is built including at least one cable management device according to the present invention. The computer receives input from the user via a mouse 806 and a keyboard 804 and outputs information or graphics to a display 802. Many other uses of the present invention will be apparent to those of skill in the art, this is but one example usage of the present invention.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A cable management device comprising:
a thin, flexible sheet including a plurality of slits, wherein said slits are configured to hold at least one electrical cable and to route said at least one cable from a first location on said sheet to a second location on said sheet.

2. The cable management device of claim 1, wherein said plurality of slits comprises pairs of slits, wherein each slit within a pair of slits is substantially parallel with the other slit.

3. The cable management device of claim 1, wherein said thin, flexible sheet is polypropylene.

4. The cable management device of claim 1, wherein said plurality of slits are die cut into said thin, flexible sheet.

5. The cable management device of claim 1, further comprising:
means for attaching said thin, flexible sheet to an enclosure.

6. The cable management device of claim 5, wherein said means for attaching are at least one adhesive layer affixed to at least a portion of a side of said thin, flexible sheet.

7. The cable management device of claim 1, wherein said thin, flexible sheet includes printed information printed onto said sheet.

8. The cable management device of claim 7, wherein said printed information is silk-screened onto said sheet.

9. The cable management device of claim 1, wherein said thin, flexible sheet is a static safe material.

10. The cable management device of claim 1, wherein said thin, flexible sheet is bent in a configuration allowing non-planar routing of said electrical cables.

11. The cable management device of claim 1, wherein said thin, flexible sheet is bent into a barrier separating at least two air flows.

12. A method for the manufacture of cable management devices comprising the steps of:
a) cutting a thin, flexible sheet to a desired size; and
b) cutting a plurality of slits in said sheet, wherein said slits are configured to hold at least one electrical cable and to route said at least one cable from a first location on said sheet to a second location on said sheet.

13. The method for the manufacture of cable management devices of claim 12, further comprising the step of:
c) affixing an attachment means to said thin, flexible sheet.

14. The method for the manufacture of cable management devices of claim 12, further comprising the step of:
c) printing information said thin, flexible sheet.

15. The method for the manufacture of cable management devices of claim 14, wherein said printing step is performed by silk-screening.

16. The method for the manufacture of cable management devices of claim 12, wherein said cutting step is performed by die cutting said thin, flexible sheet.

17. The method for the manufacture of cable management devices of claim 12, further comprising the step of:
c) bending said thin, flexible sheet into a non-planar form.

18. The method for the manufacture of cable management devices of claim 17, wherein said bending step forms said thin, flexible sheet into a barrier separating at least two air flows.

19. A cable management device comprising:
a thin, flexible sheet including a plurality of openings, wherein said openings are configured to hold at least one electrical cable and to route said at least one cable from a first location on said sheet to a second location on said sheet.

20. The cable management device of claim 19, wherein said plurality of openings comprises pairs of openings, wherein each opening within a pair of openings is substantially parallel with the other opening.

21. The cable management device of claim 19, wherein said thin, flexible sheet is polypropylene.

22. The cable management device of claim 19, wherein said plurality of openings are die cut into said thin, flexible sheet.

23. The cable management device of claim 19, further comprising:
means for attaching said thin, flexible sheet to an enclosure.

24. The cable management device of claim 23, wherein said means for attaching are at least one adhesive layer affixed to at least a portion of a side of said thin, flexible sheet.

25. The cable management device of claim 19, wherein said thin, flexible sheet includes printed information printed onto said sheet.

26. The cable management device of claim 25, wherein said printed information is silk-screened onto said sheet.

27. The cable management device of claim 19, wherein said thin, flexible sheet is a static safe material.

28. The cable management device of claim 19, wherein said thin, flexible sheet is bent in a configuration allowing non-planar routing of said electrical cables.

29. The cable management device of claim 19, wherein said thin, flexible sheet is bent into a barrier separating at least two air flows.

30. A method for the manufacture of cable management devices comprising the steps of:
a) cutting a thin, flexible sheet to a desired size; and
b) cutting a plurality of openings in said sheet, wherein said openings are configured to hold at least one electrical cable and to route said at least one cable from a first location on said sheet to a second location on said sheet.

31. The method for the manufacture of cable management devices of claim 30, further comprising the step of:
c) affixing an attachment means to said thin, flexible sheet.

32. The method for the manufacture of cable management devices of claim 30, further comprising the step of:
c) printing information said thin, flexible sheet.

33. The method for the manufacture of cable management devices of claim 32, wherein said printing step is performed by silk-screening.

34. The method for the manufacture of cable management devices of claim 30, wherein said cutting step is performed by die cutting said thin, flexible sheet.

35. The method for the manufacture of cable management devices of claim 30, further comprising the step of:
d) bending said thin, flexible sheet into a non-planar form.

36. The method for the manufacture of cable management devices of claim 35, wherein said bending step forms said thin, flexible sheet into a barrier separating at least two air flows.

37. An electrical system, comprising:
a chassis;
at least one electrical device enclosed within said chassis;
at least one cable management device, wherein said cable management device comprises a thin, flexible sheet including a plurality of slits, wherein said slits are configured to hold at least one electrical cable connected with said electrical devices and to route said at least one cable from a first location on said sheet to a second location on said sheet.

38. The electrical system of claim 37, wherein one of said electrical devices is a computer.

39. The electrical system of claim 37, further comprising:
a keyboard electrically connected with at least one of said electrical devices; and
a display electrically connected with at least one of said electrical devices, wherein said electrical devices include a computer processor.

40. An electrical system, comprising:
a chassis;
at least one electrical device enclosed within said chassis;
at least one cable management device, wherein said cable management device comprises a thin, flexible sheet including a plurality of openings, wherein said openings are configured to hold at least one electrical cable connected with said electrical devices and to route said at least one cable from a first location on said sheet to a second location on said sheet.

41. The electrical system of claim 40, wherein one of said electrical devices is a computer.

42. The electrical system of claim 40, further comprising:
a keyboard electrically connected with at least one of said electrical devices; and
a display electrically connected with at least one of said electrical devices, wherein said electrical devices include a computer processor.
